(19) United States
(12) Patent Application Publication
(10) Pub. No.: US 2007/0287317 A1
(43) Pub. Date: Dec. 13, 2007

(54) Independent Leg Seal

(76) Inventors: Rex James Reum, Spokane, WA (US); Steven Douglas Hudlet, Hayden, ID (US); Lynn Lorenz Petersen, Spokane, WA (US)

Correspondence Address: FISH & ASSOCIATES, PC;ROBERT D. FISH, 2603 Main Street, Suite 1050, Irvine, CA, 92614-6232, US

(21) Appl. No.: 11/762,227

(22) Filed: Jun. 13, 2007

Related U.S. Application Data
(60) Provisional application No. 60/813,485, filed on Jun. 13, 2006.

(51) Int. Cl. H01R 13/52

(52) U.S. Cl. 439/274

(57) ABSTRACT

A seal that has a body with at least two arms extending on each side of the body. The body also has a top and a bottom and there can be a stop on either the top, the bottom or both of the body. The arms can be in any suitable configuration, such as “C”, “V”, Omega or any Umega configurations. Among the many possibilities, there can be one or more stops extending on the top and bottom of the body or different numbers of stops on either the top, the bottom or both.

This application claims priority to U.S. provisional application Ser. No. 60/813,485 filed Jun. 13, 2006.

### FIELD OF THE INVENTION

The field of the invention is in sealing.

### BACKGROUND

Spiral wound gaskets come in all sizes and shapes and are used in numerous applications. However, there are drawbacks to spiral wound gaskets. For example, under certain circumstance where sealing has to be long lasting and durable, a standard spiral wound gasket has a high leakage rate and lacks durability. Replacing spiral wound gaskets in high temperature and high pressure applications can be difficult especially since they are not reusable.

Another problem with spiral wound gaskets is the requirement of a high clamping force which can cause significant wear and tear of sealing standard bolted flange joints. Most of the applications for spiral wound gaskets are presented not only in corrosive or erosive environments, but they are also hard to reach for servicing. For example, aerospace sealing often requires frequent and extreme temperature and pressure oscillations. Excessive joint movements for sealing standard bolted flanged joints often make it difficult for servicing. Spiral wound gaskets have not been durable enough in these types of environments.

Thus, there is still a need for an improved seal that is long lasting, durable, and reusable.

This and all other referenced patents and applications are incorporated herein by reference in their entirety. Where a definition or use of a term in a reference, which is incorporated by reference herein is inconsistent or contrary to the definition of that term provided herein, the definition of that term provided herein applies and the definition of that term in the reference does not apply.

### SUMMARY OF THE INVENTION

The present invention provides methods and apparatus in which a seal has a body from which extend at least two arms on side. Preferred embodiments also have a top and a bottom to the body. There can be a stop on either the top, the bottom or both of the body.

The arms can be in any suitable configuration, including for example, “C”, “V” or Omega configurations, which also includes any Umega configuration. Preferred embodiments also have one or more stops extending on the top and bottom of the body. There can be different number of stops on either the top, the bottom or both.

The arms, body, and optional stops can be made of any suitable material or materials, including for example, a metal alloy. Especially preferred metal alloy include at least one of nickel, chromium, and iron. titanium, and aluminum, and preferably in a face-centered cubic crystal structure or body-centered cubic crystal structure. Examples of such alloys are Inconel™ 718, Inconel 750, and Waspaloy™. The arms, especially, should be resilient. All suitable methods and compositions of accomplishing resiliency are contemplated, including using one or more polymers. The surface area where the seal makes contact with other materials should be coated. The entire seal is preferably plated.

Seal preferably have a thickness of less than 50 mm, and a thickness of at least 1 mm. Preferred seals also preferably define a cavity with a diameter of less than 1500 cm., and have a cavity with a diameter of at least 0.5 cm. At least of the arms is in combination with a centering ring.

### BRIEF DESCRIPTION OF THE DRAWINGS

FIG. 1 is a cross-section drawing of one edge of a seal according to the inventive subject matter.

FIG. 2 is a top plane view of a seal according to the inventive subject matter.

FIG. 3 is a cross-section drawing of a seal according to the inventive subject matter.

### DETAILED DESCRIPTION

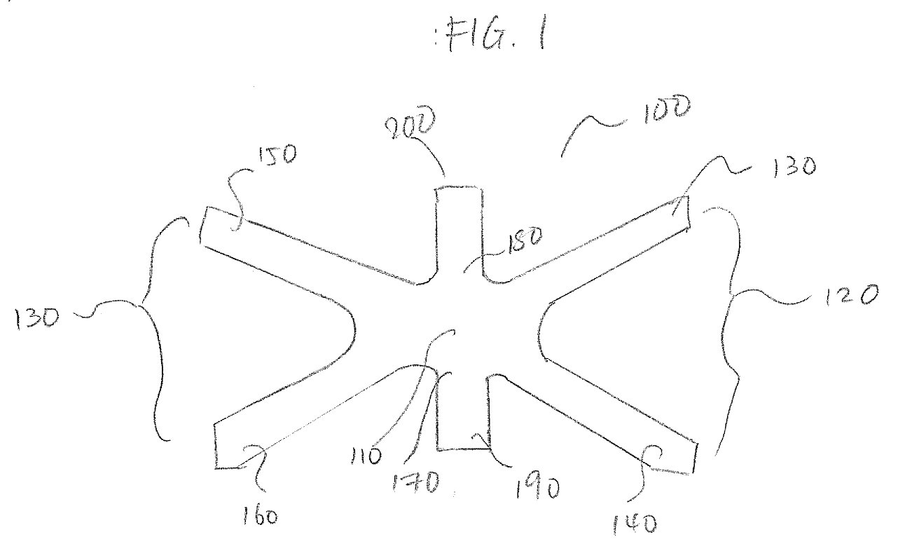

In an exemplary configuration as depicted in FIG. 1, a seal 100 generally comprises a body 110, two sides 120 and 130, two arms 130, 140, 150, and 160 on each side.

A body 110 is where the two sides of the seal can join together. Body 110 also has a top 180 and a bottom 170. Preferably, stops 190 and 200 can be joined at top 180 and bottom 170 of body 110. There can be multiple numbers of stops on top 180 and bottom 170. It is also contemplated that the number of stops on top and bottom can be different from each other.

Each side 120 and 130 can have two arms 130, 140, 150 and 160. Preferably, the arms are in C configuration, but it is contemplated that the arms can be in different configuration from each other, such as C, V, Omega, or Umega configuration. Preferably, the seal is held in the proper position by a metal positioning ring (not shown) and effectively seal against flange thermal and pressure movements in all types of environment. Different configurations of the arms allow for a tighter sealing in different kinds of applications. It is contemplated that seal is used with standard bolted flanged joints and increases thermal and pressure cycling performance and decrease low long term leak rates.

The arms, body, and optional stops can be made of any suitable material or materials, including for example, a metal alloy. Especially preferred metal alloy include at least one of nickel, chromium, and iron. titanium, and aluminum, and preferably in a face-centered cubic crystal structure or body-centered cubic crystal structure. Examples of such alloys are Inconel™ 718, Inconel 750, and Waspaloy™. The arms, especially, should be resilient. All suitable methods and compositions of accomplishing resiliency are contemplated, including using one or more polymers.

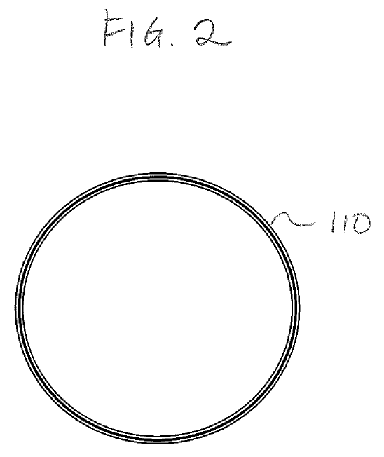

Preferred embodiment includes plating the entire seal, see FIG. 2, in which the entire seal 110 is plated. This includes plating the body, the sides, the arms on the sides and the optional stops. The surface area where seal makes contact with other materials should be coated. Being made of metal, seal does not degrade over time like spiral wound gaskets. This results in fewer service disassemblies over time. Seals can endure low or high temperature, or frequent temperature and/or pressure oscillations. Seals can also be replaced separately from the positing ring to reduce seal replacement costs.

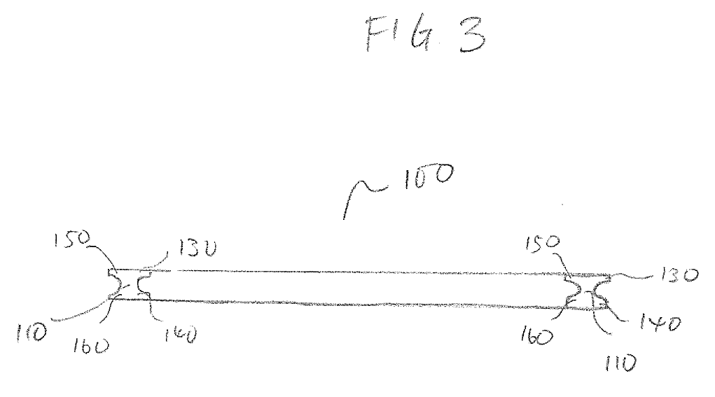

FIG. 3 shows a cross section of seal 100 with arms 130, 140, 150 and 160 on each side of body 110. Preferably, the seal has a thickness of less than 50 mm, and a thickness of at least 1 mm. Also preferably, the seal defines a cavity with a diameter of less than 1500 cm. and have a cavity with a diameter of at least 0.5 cm. The arms are in combination with a centering ring (not shown). It is contemplated, that besides a standard size, seal can be customized to accommodate any sizes, shapes and configuration to adapt to almost any application requirement.

The seal assembly is sized to replace spiral wound gaskets in existing applications. Requiring only about one quarter of the clamping force of a spiral wound gasket, bolted flange joints are easier to make with seal. Other benefits include lower long-term leak rate in thermal and pressure cycle conditions.

It should be apparent to those skilled in the art that many more modifications besides those already described are possible without departing from the inventive concepts herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps could be present, or utilized, or combined with other elements, components, or steps that are not expressly referenced. Where the specification claims refers to at least one of something selected from the group consisting of A, B, C . . . . and N, the text should be interpreted as requiring only one element from the group, not A plus N, or B plus N, etc.

What is claimed is:

1. A seal, comprising first and second arms on each of two sides, and a body.

2. The seal of claim 1, further comprising a stop on a top and/or a bottom of the body.

3. The seal of claim 2, wherein the top and the bottom comprises a different numbers of stops.

4. The seal of claim 1, wherein the first and second arms on a first of the two sides are arranged in a C seal configuration.

5. The seal of claim 1, wherein the first and second arms on a first of the two sides are arranged in a V seal configuration

6. The seal of claim 1, wherein the first and second arms on a first of the two sides are arranged in an Omega seal.

7. The seal of claim 1, wherein each of the two sides have a different configuration of the arms.

8. The seal of claim 1, wherein at least one of the arms comprises a metal alloy.

9. The seal of claim 1, wherein the metal alloy comprises at least one of nickel, chromium, and iron. titanium, and aluminum.

10. The seal of claim 1, wherein metal alloy comprises at least one of face-centered cubic crystal structure and body-centered cubic crystal structure.

11. The seal of claim 1, wherein metal alloy comprises Inconel™ 718, Inconel 750, and Waspaloy™.

12. The seal of claim 1, wherein at least one of the arms comprises a material with properties that is resilient.

13. The seal of claim 13, wherein the material comprises a polymer.

14. The seal of claim 1, wherein each of the two sides and the body are plated.

15. The seal of claim 1, further comprising a contacting surface area that extends from each of the two sides and the body.

16. The seal of claim 15, wherein the contacting surface area is coated.

17. The seal of claim 1, having a thickness of less than 50 mm.

18. The seal of claim 1, wherein the seal defines a cavity with a diameter of less than 1500 cm.

19. The seal of claim 1, wherein the seal defines a cavity with a diameter of at least 0.5 cm.

20. The seal of claim 1, wherein at least of the arms is in combination with a centering ring.
